(19) United States
(12) Patent Application Publication
(10) Pub. No.: US 2024/0402300 A1
(43) Pub. Date: Dec. 5, 2024

(54) Method for estimating the dimensions of an object from points acquired by a lidar sensor

(71) Applicant: Continental Autonomous Mobility Germany GmbH, Ingolstadt (DE)

(72) Inventors: Harrison SPORTES, Toulouse (FR); Boris LUGEZ, Toulouse (FR)

(73) Assignee: Continental Autonomous Mobility Germany GmbH, Ingolstadt (DE)

(21) Appl. No.: 18/672,171

(22) Filed: May 23, 2024

(30) Foreign Application Priority Data
May 31, 2023 (FR) FR2305420

(51) Int. Cl. G01S 7/48; G01S 17/58; G01S 17/931

(52) U.S. Cl. CPC G01S 7/4802; G01S 17/58; G01S 17/931

(57) ABSTRACT

Examples present a method for at least one dimension belonging to a reflective surface of an object including: a lidar acquiring a set of points; selecting light beams from a group of points of the same object; estimating, from the three-dimensional coordinates of the points, the values of a first and of a second dimension of the object; estimating, from the intensity values of the points, a reflectivity value for the object; then for at least one specific point in the group: estimating a cross section of a light beam; estimating a theoretical intensity value received by the lidar sensor after the beam is emitted; determining an intensity error associated with the specific point from a difference between the estimated theoretical intensity and the measured intensity; and correcting the estimate of the value of the first dimension on the basis of the intensity error.

### CROSS REFERENCE TO RELATED APPLICATION

This application claims priority to French Application No. 2305420, filed May 31, 2023, the contents of such application being incorporated by reference herein.

### Field of the Invention

The present disclosure relates to the field of processing data acquired by a lidar sensor.

### BACKGROUND OF THE INVENTION

A lidar (light detection and ranging) sensor is a sensor which emits light waves and determines, from the reflection of these light waves, a dot matrix representing an environment of the lidar.

A lidar sensor may be used to carry out measurements of an object in its environment by acquiring a point cloud representing the environment of the lidar sensor, the object then being represented by a plurality of points in the point cloud. Notably, when the lidar sensor is installed in a vehicle, it may, for example, be used to detect objects present on the road. In the context of drive assist functions, in particular of autonomous driving functions, detecting and determining the dimensions of an object present on the road makes it possible for the vehicle to react accordingly. In particular, when it is a small object, the precise dimensions of this object may make it possible to determine whether the vehicle can pass over the object without risking a collision.

However, determining the dimensions of the objects, and more particularly of small objects situated a few tens of meters from the vehicle, is limited by the resolution of the lidar sensor, so that the objects may sometimes be under- or overdimensioned.

The present disclosure is intended to improve this situation.

### SUMMARY OF THE INVENTION

In this regard, a method for estimating at least one dimension belonging to a reflective surface of an object is proposed, the method being implemented by a device comprising at least one lidar sensor, computer and memory, the memory storing a model of the object comprising a first dimension and a second dimension of the reflective surface of the object and a reflectivity of the reflective surface of the object, the method comprising:
the lidar sensor acquiring a set of points, each point being associated with three-dimensional coordinates in space and with an intensity value;
selecting, from the set of points, a group of points which are presumed to belong to the same object;
estimating, from the three-dimensional coordinates of the points in the group of points, values of a first and of a second dimension of the object corresponding to the first and to the second dimension, respectively, of the reflective surface of the model of the object;
estimating, from the intensity values of the group of points which are presumed to belong to the object, a reflectivity value for the object corresponding to the reflectivity of the reflective surface of the model of the object; then
for at least one specific point in the group of points which are presumed to belong to the object:
   estimating a cross section of a specific light beam, the reflection of which by the reflective surface of the object made it possible to obtain the specific point, from the estimated dimensions of the reflective surface of the object and from a divergence of the light beam determined from a distance between the specific point and the lidar sensor;
   estimating a theoretical intensity value received by the lidar sensor after the specific light beam is emitted, from the estimated cross section of the specific light beam and from the estimated reflectivity value for the reflective surface;
   determining an intensity error associated with the specific point from a difference between the estimated theoretical intensity value and the measured intensity value which is associated with the specific point after the specific light beam is emitted; and
correcting the estimate of the value of the first dimension on the basis of the intensity error associated with at least one specific point.

Optionally, correcting the estimate of the value of the first dimension on the basis of the intensity error associated with at least one specific point comprises minimizing an error of a cost function calculated from the intensity error associated with at least one specific point by iteratively varying the value of the first dimension.

Optionally, the method further comprises correcting the estimate of the value of the second dimension on the basis of the intensity error associated with at least one specific point, the correction comprising minimizing an error of a cost function calculated from the intensity error associated with at least one specific point by iteratively varying the value of the second dimension.

Optionally, the method further comprises correcting the estimate of the value of the reflectivity from the intensity error associated with at least one specific point, the correction comprising minimizing an error of a cost function calculated on the basis of the intensity error associated with at least one specific point by iteratively varying the value of the reflectivity.

Optionally, the cost function corresponds to the sum of the intensity errors of the specific points for which the intensity error was determined.

Optionally, the first dimension of the model of the object corresponds to a height of the reflective surface of the object and the second dimension of the model of the object corresponds to a width of the reflective surface of the object.

Optionally, the theoretical intensity value received by the lidar sensor after the specific light beam is emitted is estimated from a function characterizing the intensity received by the lidar after a light beam emitted by the lidar sensor is reflected on a surface as a function of:
a) a distance between this surface and the lidar sensor,
b) a reflectivity of this surface, and
c) a cross section of the light beam reflected on this surface.

Optionally, the plurality of points is enriched by new acquisitions of the lidar sensor and the method is implemented iteratively from the enriched plurality of points.

Optionally, the method further comprises determining a trajectory of a vehicle in which the device is installed from the corrected estimate of the value of the first dimension.

The application also bears on a device comprising at least one lidar sensor, computer and memory, the device being configured to implement any one of the methods which are presented by the present disclosure. Notably, the device may be installed in a vehicle.

The application bears, furthermore, on a computer program product comprising instructions for implementing any one of the methods which are presented by the present disclosure when this program is executed by a processor.

Finally, the application bears on a computer-readable non-transient storage medium on which is stored a program for implementing any one of the methods which are presented by the present disclosure when this program is executed by a processor.

The method according to the present disclosure thus makes it possible to estimate the length of at least one side of the reflective surface of an object sensed by the lidar sensor precisely, and notably more precisely than a conventional estimate based only on the three-dimensional coordinates of the points presumed to belong to the object, it being possible for these dimensions to be under- or overestimated because of the resolution of the lidar sensor. In certain options, the method is intended to estimate the length of the two sides of the reflective surface of the object (width L and height h). These estimates of the dimensions of the reflective surface of the object may notably be used in order to determine a trajectory of the vehicle adapted to the precise dimensions of the object, which may make it possible to avoid situations in which a trajectory of the vehicle determined on the basis of underestimated dimensions of the object might be damaging for the safety of the vehicle and road users.

### BRIEF DESCRIPTION OF THE DRAWINGS

Other features, details and advantages will become apparent from reading the detailed description below and from analyzing the appended drawings, in which:

FIG. 1 schematically depicts a device which makes it possible to perform a method for estimating a dimension belonging to a reflective surface of an object.

FIG. 2 depicts an example of a lidar sensor installed in a vehicle.

FIG. 3 depicts an example of a method for estimating at least one dimension belonging to a reflective surface of an object. FIG. 4 depicts an example of a cross section of light beams which are emitted by the lidar sensor and reflected by the reflective surface of an object.

### DETAILED DESCRIPTION OF THE PREFERRED EMBODIMENTS

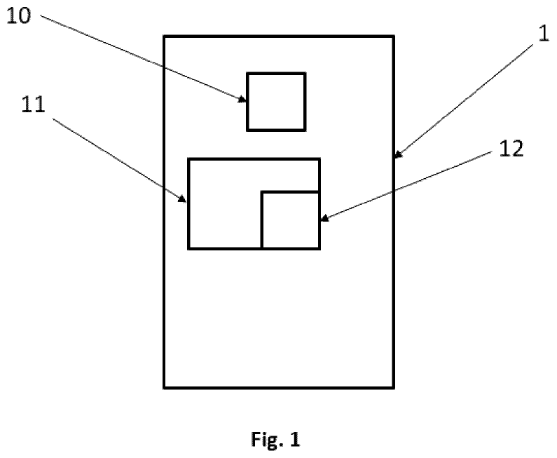

An example of a device 1 which makes it possible to perform a method for estimating a dimension belonging to a reflective surface of an object is now described with reference to FIG. 1.

The device 1 may be adapted to be installed in a vehicle 2.

The device 1 comprises a lidar (light detection and ranging) sensor 10, a computer 11 and a memory 12.

The memory 12 may store the code instructions which are executed by the computer 11 and make it possible to control the acquisition of data by the lidar sensor 10 as well as their processing. The computer 11 therefore has access to the information stored in memory. The memory 12 may also be adapted to store the data acquired by the lidar sensor 10.

The memory 12 may, for example, comprise a ROM (read-only memory), a RAM (random access memory), an EEPROM (electrically erasable programmable read-only memory) or any other type of adapted storage means. The memory may, for example, comprise optical, electronic or indeed magnetic storage means.

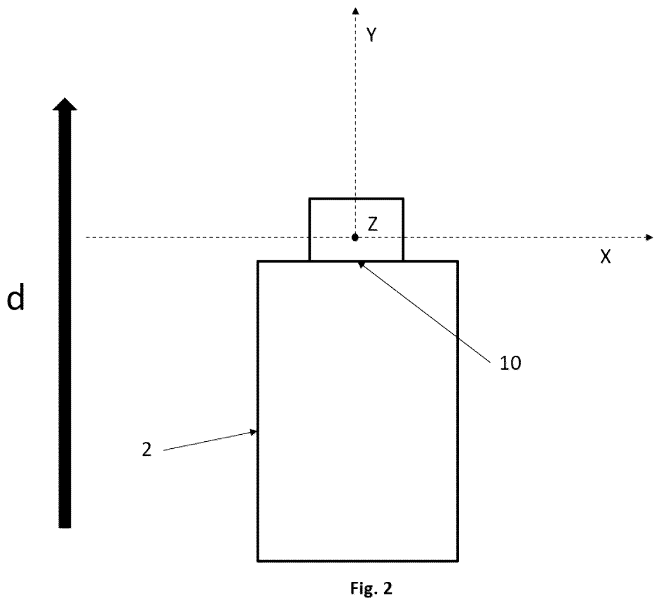

The lidar sensor 10 is adapted to acquire three-dimensional point clouds (x, y, z) representing the environment of the vehicle 2 and notably representing the front environment of the vehicle. The lidar sensor 10 may thus be oriented to emit light beams representing the environment in front of the vehicle, that is to say in its direction of motion represented by the arrow d in FIG. 2. The lidar sensor 10 may, for example, be mounted on the body at the front of the vehicle 2.

As far as the three-dimensional coordinates are concerned, the x-coordinate of a point corresponds to an abscissa coordinate of the point with respect to the sensor 10. The y-coordinate of a point corresponds to an ordinate coordinate of the point with respect to the sensor 10. The z-coordinate of a point corresponds to an elevation coordinate of the point with respect to the lidar sensor 10. In FIG. 2, and supposing the outline of the vehicle 2 and of the lidar sensor 10 which is depicted in plan view, the abscissa axis X and ordinate axis Y of the lidar sensor 10 are depicted. The elevation axis Z of the sensor 10 is perpendicular to the axes X and Y. In this FIG. 2, the lidar sensor 10 is therefore mounted at the front of the vehicle and is oriented to emit light beams in the direction of motion of the vehicle.

Each point acquired by the lidar sensor 10 is also associated with an intensity value. This is the intensity received by the lidar sensor after the light beam is reflected on a surface.

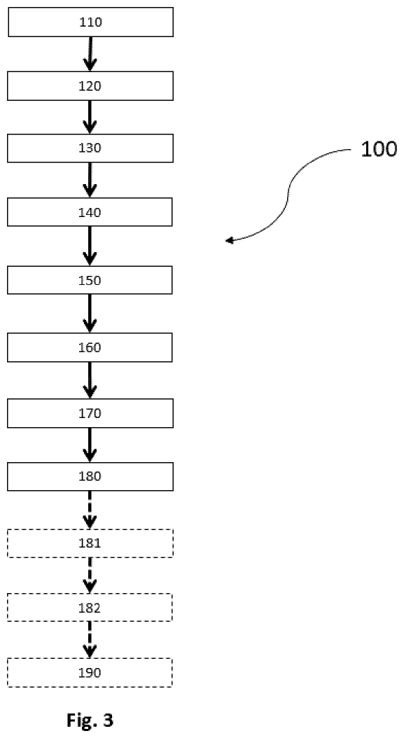

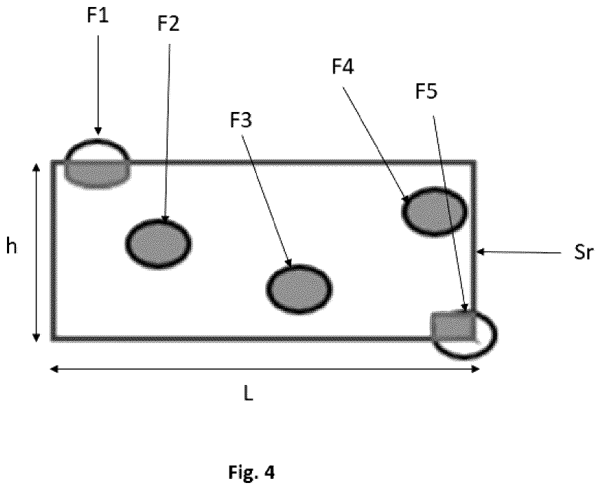

An example of a method 100 which the device 1 according to the present disclosure is configured to implement is now presented with reference to FIG. 3. In particular, the device 1 is configured to implement a method for estimating at least one dimension belonging to a reflective surface of an object. The reflective surface of the object corresponds to a surface of the object which reflected the light beams emitted by the lidar sensor 10. A dimension of this surface designates, in this instance, a height or a width of this surface. It is therefore a case of estimating the length of at least one side of this surface precisely, and notably more precisely than a conventional estimate based only on the three-dimensional coordinates of the points presumed to belong to the object. Indeed, such an estimate is notably limited by the resolution of the lidar sensor 10 so that, for objects situated at a far distance from the lidar sensor, the error rate in the estimated dimensioning of the object relative to the size of the object may be high.

In order to make this estimate possible, the memory 12 stores a model of the object comprising a first dimension, for example a height h, and a second dimension, for example a width L, of the reflective surface of the object. The model of the object also comprises a reflectivity of the reflective surface of the object. The model of the object therefore comprises three parameters: the first and the second dimension of the reflective surface of the object, and the reflectivity of the reflective surface of the object. Reflectivity is a datum which translates the more or less reflective nature of the reflective surface of the object to light and therefore the more or less reflective nature of the reflective surface of the object to the light beams emitted by the lidar sensor 10. One of the objectives of the method is to determine precise values for the reflective surface of the object by estimating the values of the parameters of the model as developed in the remainder of the document.

In this case, the method 100 rests on the fact that a light beam emitted by a lidar sensor 10 diverges as it propagates. It is therefore not concentrated at a single point at the moment of striking the surface on which it is reflected (referred to as the reflective surface below). It is a case, in reality, of a cross section of the light beam which strikes the reflective surface. This cross section has an overall elliptical shape when the whole of the beam is reflected by the reflective surface. In addition, this cross section, insofar as the whole of the beam is reflected by the reflective surface, is bigger the further the reflective surface is from the lidar sensor 10 since the light beam diverges more and more as it moves away from the lidar sensor 10. Consequently, the intensity of the light beam reflected by the reflective surface of the object and sensed by the lidar sensor 10 depends on the cross section of the light beam actually reflected by the reflective surface of the object. In particular, the reflective cross section of an emitted light beam for a point acquired on an edge of the reflective surface of an object at a given distance will not correspond to a complete theoretical cross section of the light beam striking this surface, which means, concretely, that a complementary cross section of the light beam will not be reflected by the reflective surface. This situation is notably depicted in FIG. 4, which illustrates a reflective surface Sr and five light beams F1 to F5, three of which are totally reflected by the reflective surface Sr (namely the light beams F2, F3 and F4) and two of which are partially reflected by this surface Sr (namely the light beams F1 and F5). In this instance, the intensity measured by the lidar sensor 10 will be lower for the points F1 and F5 than for the points F2 to F4 if it is supposed that the whole of the reflective surface Sr has the same reflectivity. As explained below, the method 100 ingeniously uses the intensity information for the points which are associated with the reflective surface Sr of an object to correct a first estimate of at least one dimension of this reflective surface Sr carried out from the three-dimensional coordinates of the points. In this way, the dimensions of the reflective surface Sr of an object which is sensed by a lidar sensor 10 are no longer estimated only from just the three-dimensional coordinates of the points belonging to this object but also from the intensity associated with these points by using the correlation between this intensity and the reflective cross section of the light beams which are associated with these points on the reflective surface Sr. Consequently, the method 100 makes it possible to reduce the number of collisions which are due to objects the precision of the estimate of the dimensions of which is limited because of the resolution of the lidar sensor 10. Notably, in the context of autonomous driving functions, the vehicle may be made to modify its trajectory when an object, for example a tire, is present on the road in front of it. In this case, precisely determining the width and the height of the object is vital for determining the trajectory of the vehicle, whether it is a case of bypassing the object or merely of passing over the object, between the wheels of the vehicle, when the height of the object allows. This is particularly advantageous when the vehicle is traveling at high speed and when it is necessary to take a decision extremely quickly. It is understood that a decision, such as emergency braking or sudden swerving of the vehicle, which would not be taken insofar as the dimensions of the object which is detected by the lidar sensor would have been underestimated, poses safety questions insofar as the measurement where a more precise estimate, as proposed by the method according to the present disclosure, would have made it possible to take the most appropriate decision.

The method 100 thus comprises an operation 110, as illustrated by FIG. 3, of the lidar sensor 10 acquiring a set of points. Each point acquired by the lidar sensor 10 is associated with three-dimensional coordinates (x, y, z) in space and with an intensity value.

The method 100 comprises an operation 120, as illustrated by FIG. 3, of selecting, from the set of points acquired by the lidar sensor 10, a group of points which are presumed to belong to the same object.

In some examples, the group of points is selected 120 on the basis of the nearest neighbor criterion. In other words, selecting 120 the group of points may comprise selecting a set of points from which the distance to their nearest neighbor is below a predetermined distance threshold.

Of course, the method 100 may comprise selecting several groups of points if several groups of points may be determined as presumed to each belong to the same object. The following operations of the method 100 may then be implemented for each of the groups of points which are determined at the end of the operation 120.

The method 100 comprises an operation 130, as illustrated by FIG. 3, of estimating the values of a first dimension and of a second dimension of the object. The first dimension and the second dimension of the object correspond to the first dimension and the second dimension, respectively, of the reflective surface of the model of the object. These values are estimated from the three-dimensional coordinates of the points in the group of points which are selected at the end of the operation 120.

In some examples, the values of the first and of the second dimension may be estimated from the points in the group of points having the most extreme coordinates on the abscissa (x) axis and on the elevation (z) axis. Notably, in some examples, the value of the first dimension, when this is the height h of the reflective surface Sr of the object, may correspond to a difference between the highest elevation value associated with a point in the group of points and the lowest elevation value associated with a point in the group of points. In some examples, the value of the first dimension, when this is the width of the reflective surface Sr of the object, may correspond to a difference between the highest abscissa value associated with a point in the group of points and the lowest elevation value associated with a point in the group of points. Thus, the operation 130 makes it possible to obtain a first estimate of the dimensions of the reflective surface of the object which is detected by the lidar sensor 10 from the three-dimensional coordinates of the points in the group of points which are presumed to belong to the object.

The method 100 comprises an operation 140, as illustrated by FIG. 3, of estimating a reflectivity value for the object. The reflectivity value for the object corresponds to the reflectivity of the reflective surface of the model of the object. This reflectivity value for the object is estimated from the intensities of the points in the group of points which are presumed to belong to the object. In some examples, a reflectivity of a point in the set of points may be determined from a distance between the point and the lidar sensor, from an intensity of the light beam which made it possible to obtain the point and from an intensity received by the lidar sensor after this beam is reflected. Thus, in some examples, the reflectivity of the object may be determined as corresponding to an average of the reflectivities of the points in the group of points which are presumed to belong to the object. In other examples, the reflectivity of the object may be determined as corresponding to an average of the reflectivity values for a selection of points belonging to the group of points. It is a case, in these other examples, of selecting a small number of points in order to determine the reflectivity of the object, for example by removing the points the intensity values for which are manifestly incorrect. It is therefore supposed, in this operation, that the reflective surface of the object has a substantially uniform reflectivity.

After the operation 140, several operations will be carried out for at least one specific point in the group of points. These operations are advantageously carried out for each point in the group of points which are presumed to belong to the object.

The method 100 comprises an operation 150, as illustrated by FIG. 3, of estimating a cross section of a specific light beam, the reflection of which by the reflective surface of the object made it possible to obtain the specific point. It is therefore a case, in this operation, of estimating the cross section of the light beam which was actually reflected by the light beam. As explained above, it is understood that a cross section associated with a point acquired by the lidar sensor 10 and corresponding to a point positioned in the middle of the reflective surface Sr of the object will correspond to the entire cross section of the light beam emitted by the lidar sensor 10. Conversely, a cross section associated with another point acquired by the lidar sensor 10 and corresponding to a point positioned on an end of the reflective surface Sr of the object will correspond to a reduced cross section with respect to the entire cross section of the light beam emitted by the lidar sensor 10. These are situations explained above with reference to FIG. 4.

In some examples, the cross section of the specific light beam the reflection of which by the reflective surface of the object made it possible to obtain the specific point is estimated from the estimated dimensions of the reflective surface of the object and from a divergence of the light beam determined from a distance between the specific point and the lidar sensor. Indeed, the divergence of the light beam emitted by the lidar sensor 10 increases with distance. Consequently, knowing the orientation of the lidar sensor and the distance at which the specific point is situated with respect to the lidar sensor 10 using its three-dimensional coordinates, it is possible to determine the theoretical cross section of the light beam at this distance. It is therefore possible to determine the projection of this cross section onto the reflective surface Sr of the object knowing the orientation of the specific light beam and the dimensions of this reflective surface Sr, which were estimated during the operation 130. A distance between the specific point and the lidar sensor 10 corresponds to the Euclidean distance between the specific point and the lidar sensor 10.

The method 100 comprises an operation 160, as illustrated by FIG. 3, of estimating a theoretical intensity value received by the lidar sensor after the specific light beam is emitted, from the estimated cross section of the specific light beam and from the estimated reflectivity value for the reflective surface. It is a case, in this step, of estimating a theoretical intensity which the lidar sensor 10 should have received after the light beam is reflected on the reflective surface Sr of the object relative to the cross section of the light beam reflected on this surface estimated during the operation 150 and relative to the reflectivity of this surface estimated during the operation 140.

Thus, when the intensity estimated for the specific point does not correspond to the intensity actually measured by the lidar sensor 10 for the specific point, the cross section of the light beam estimated as having been reflected by the reflection surface comprises an error since it is from this cross section that the theoretical intensity is calculated. Now, the cross section of the light beam is itself estimated from the dimensions of the reflective surface, so that it is these estimated dimensions of the reflective surface which are incorrect. Thus, by comparing the theoretical intensity value to the intensity value actually measured by the lidar sensor 10 for the specific point, the method makes it possible to obtain information on the precision of the dimensions of the reflective surface which are estimated during the operation 130.

In some examples, the theoretical intensity value received by the lidar sensor after the specific light beam is emitted is estimated from a function characterizing the intensity received by the lidar sensor after a light beam emitted by the lidar sensor is reflected on a surface as a function of:
a) a distance between this surface and the lidar sensor,
b) a reflectivity of the surface, and
c) a cross section of the light beam reflected by this surface.

This function may, for example, be predetermined empirically from acquisitions of one or more lidar sensors, advantageously from acquisitions of the lidar sensor 10, by varying the reflectivity of the reflective surfaces of the objects, their position with respect to the lidar sensor and the cross section of the light beams which are reflected by the reflective surface of these objects.

Thus, by using the various parameters of this function with the distance between the specific point and the lidar sensor, the reflectivity of the reflective surface of the object estimated during the operation 140 and the cross section of the light beam reflected by the reflective surface of the object which made it possible to obtain the specific point estimated during the operation 150, the function makes it possible to calculate the theoretical intensity value for the operation 160.

The method 100 comprises an operation 170, as illustrated by FIG. 3, of determining an intensity error associated with the specific point. The intensity error associated with the specific point is obtained from a difference between the theoretical intensity value estimated during the operation 160 and the intensity value which is actually measured by the lidar sensor 10 and associated with the specific point after the specific light beam is emitted. As explained above, this intensity error translates an error in the estimate of the dimensions of the reflective surface Sr of the object.

The operations 140, 150, 160 and 170 are therefore carried out for at least one specific point, and advantageously for each point in the group of points which are presumed to belong to the same object. Consequently, at the end of the operation 170, at least one intensity error associated with a specific point has been calculated.

The method then comprises an operation 180, illustrated in FIG. 3, of correcting the estimate of the value of the first dimension on the basis of the intensity error associated with at least one specific point.

In some examples, the operation 180 of correcting the estimate of the value of the first dimension comprises correcting the estimate of the value of the first dimension in order to reduce the at least one intensity error.

In first examples, the operation 180 of correcting the estimate of the value of the first dimension from the intensity error associated with at least one specific point may comprise minimizing an error of a cost function calculated from the intensity error associated with at least one specific point by iteratively varying the value of the first dimension. In these first examples, the cost function expresses the error to be minimized as a function of the value of the first dimension of the model of the object.

In second examples, which are complementary to the first examples, the method may comprise an operation 181 of correcting the estimate of the value of the second dimension on the basis of minimizing the error of the cost function calculated from the intensity error associated with at least one specific point by iteratively varying the value of the second dimension. In these second examples, the cost function expresses the error to be minimized as a function of the value of the first dimension and of the second dimension of the model of the object.

In third examples, which are complementary to the first examples and possibly to the second examples, the method may comprise an operation 182 of correcting the estimate of the value of the reflectivity on the basis of minimizing the error of the cost function calculated from the intensity error associated with at least one specific point by iteratively varying the value of the reflectivity. In these third examples, the cost function expresses the error to be minimized as a function of the value of the first dimension and the value of the reflectivity of the model of the object. When these third examples are implemented in addition to the second examples, the cost function expresses the error to be minimized as a function of the value of the first dimension, of the value of the second dimension and of the value of the reflectivity of the model of the object.

Iteratively varying a parameter of the model of the object should be understood as choosing a value of this object in a given iteration and implementing the operations 140 to 170 again, taking this new value of the parameter of the model into consideration.

In the first, and possibly second and/or third, examples, the error to be minimized of the cost function may correspond to the sum of the intensity errors which are associated with the specific points for which the intensity error was determined during the operation 170.

Thus, by iteratively varying the first-dimension value, by optionally iteratively varying the value of the second dimension and/or the value of the reflectivity of the model of the object and by implementing the operations 140 to 170 again in each iteration, it is possible, with an optimization algorithm, to minimize the error of the cost function, which is determined from the at least one intensity error determined at the end of the operation 170. Minimizing the error of the cost function by iteratively varying the first dimension, and optionally the values of the second dimension and of the reflectivity, therefore means determining new values minimizing the sum of the differences between the real intensities of the specific points in the group of points and their theoretical intensity which are determined at the end of the operation 170. This amounts to considering that the cross section of the light beams which is associated with the specific points in the group of points which are presumed to belong to the object and is estimated during the operation 150 is closer to the cross section of the light beams which is actually reflected by the reflective surface of the object for acquiring these points. Now, this cross section is determined from the dimensions of the reflective surface of the object so that, when the error of the cost function decreases, that means that the dimensions of the reflective surface are closer to the real dimensions of the reflective surface than when they were only estimated from the three-dimensional coordinates of the points in the group of points which are presumed to belong to the object. The method 100 therefore makes it possible to estimate the value of the first dimension, and possibly the values of the second dimension and/or of the reflectivity of the reflective surface, more precisely than the values obtained from the three-dimensional coordinates of the points.

In the first, and possibly second and/or third, examples, the iterative variation of the values of the parameters of the model of the object to be corrected in order to minimize the error of the cost function is determined by an optimization algorithm. In some examples, the optimization algorithm chosen in order to determine the iterative variation of the values of the parameters of the model of the object to be corrected may, for example, correspond to a Levenberg-Marquadt algorithm.

In some examples in which several parameters of the model of the object are corrected by minimizing the cost function, the cost function expresses the error to be minimized as a function of the values of the parameters of the model of the object to be corrected and minimizing the cost function comprises calculating the Jacobian matrix of the error to be minimized as a function of the parameters of the model of the object which are expressed in the cost function. Calculating the Jacobian matrix of the error of the cost function as a function of the parameters of the model of the object to be corrected makes it possible to optimize the convergence of the optimization algorithm towards minimizing the error by determining the relative impact of the variations in each parameter of the model of the object on minimizing the error of the cost function.

In some examples, and as illustrated by FIG. 3, the method 100 may further comprise an operation 190 of determining a trajectory of the vehicle from the corrected estimate of the value of the first dimension determined during the operation 180. The trajectory of the vehicle may also be determined from the corrected estimate of the value of the second dimension determined during the operation 181. The trajectory of the vehicle may, for example, be determined so as to avoid the object the dimensions of which were recalculated during the method 100.

In some examples, the plurality of points which are acquired by the lidar sensor 10 and on which the method is implemented is enriched by new acquisitions of the lidar sensor 10 and the method is implemented iteratively from the enriched plurality of points. In this case, the more points there are in a group of points which are presumed to belong to the same object, the more precisely its dimensions will be able to be determined thanks to the method according to the present disclosure.

Thus, the method 100 according to the present disclosure makes it possible to estimate the length of at least one side of the reflective surface of an object sensed by the lidar sensor 10 precisely, and notably more precisely than a conventional estimate based only on the three-dimensional coordinates of the points presumed to belong to the object, it being possible for these dimensions to be under- or overestimated because of the resolution of the lidar sensor 10. In some examples, the method 100 is intended to estimate the length of the two sides of the reflective surface of the object (width L and height h). These estimates of the dimensions of the reflective surface of the object may notably be used in order to determine a trajectory of the vehicle adapted to the precise dimensions of the object, which may make it possible to avoid situations in which a trajectory of the vehicle determined on the basis of underestimated dimensions of the object might be damaging for the safety of the vehicle and road users.

1. A method for estimating at least one dimension belonging to a reflective surface of an object, the method being implemented by a device comprising at least one lidar sensor, computer and memory, the memory storing a model of the object comprising a first dimension and a second dimension of the reflective surface of the object and a reflectivity of the reflective surface of the object, the method comprising:
the lidar sensor acquiring a set of points, each point being associated with three-dimensional coordinates in space and with an intensity value;
selecting, from the set of points, a group of points which are presumed to belong to the same object;
estimating, from the three-dimensional coordinates of the points in the group of points, values of a first and of a second dimension of the object corresponding to the first and to the second dimension, respectively, of the reflective surface of the model of the object;
estimating, from the intensity values of the group of points which are presumed to belong to the object, a reflectivity value for the object corresponding to the reflectivity of the reflective surface of the model of the object; then
for at least one specific point in the group of points which are presumed to belong to the object:
estimating a cross section of a specific light beam, the reflection of which by the reflective surface of the object made it possible to obtain the specific point, from the estimated dimensions of the reflective surface of the object and from a divergence of the light beam determined from a distance between the specific point and the lidar sensor;
estimating a theoretical intensity value received by the lidar sensor after the specific light beam is emitted, from the estimated cross section of the specific light beam and from the estimated reflectivity value for the reflective surface;
determining an intensity error associated with the specific point from a difference between the estimated theoretical intensity value and the measured intensity value which is associated with the specific point after the specific light beam is emitted; and
correcting the estimate of the value of the first dimension on the basis of the intensity error associated with at least one specific point.

2. The method as claimed in claim 1, wherein correcting the estimate of the value of the first dimension on the basis of the intensity error associated with at least one specific point comprises minimizing an error of a cost function calculated from the intensity error associated with at least one specific point by iteratively varying the value of the first dimension.

3. The method as claimed in claim 1, further comprising:
correcting the estimate of the value of the second dimension from the intensity error associated with at least one specific point, the correction comprising minimizing an error of a cost function calculated from the intensity error associated with at least one specific point by iteratively varying the value of the second dimension.

4. The method as claimed in claim 1, further comprising:
correcting the estimate of the value of the reflectivity on the basis of the intensity error associated with at least one specific point, the correction comprising minimizing an error of a cost function calculated from the intensity error associated with at least one specific point by iteratively varying the value of the reflectivity.

5. The method as claimed in claim 2, wherein the error of the cost function corresponds to the sum of the intensity errors of the specific points for which the intensity error was determined.

6. The method as claimed in claim 1, wherein the first dimension of the model of the object corresponds to a height of the reflective surface of the object and wherein the second dimension of the model of the object corresponds to a width of the reflective surface of the object.

7. The method as claimed in claim 1, wherein the theoretical intensity value received by the lidar sensor after the specific light beam is emitted is estimated from a function characterizing the intensity received by the lidar after a light beam emitted by the lidar sensor is reflected on a surface as a function of:
a) a distance between this surface and the lidar sensor,
b) a reflectivity of this surface, and
c) a cross section of the light beam reflected on this surface.

8. The method as claimed in claim 1, wherein the plurality of points is enriched by new acquisitions of the lidar sensor and the method is implemented iteratively from the enriched plurality of points.

9. The method as claimed in claim 1, further comprising determining a trajectory of a vehicle in which the device is installed from the corrected estimate of the value of the first dimension.

10. A device comprising at least one lidar sensor, computer and memory, the device being configured to implement the method as claimed in claim 1.

11. A vehicle in which a device as claimed in claim 10 is installed.

12. The method as claimed in claim 1, further comprising: correcting the estimate of the value of the second dimension from the intensity error associated with at least one specific point, the correction comprising minimizing an error of a cost function calculated from the intensity error associated with at least one specific point by iteratively varying the value of the second dimension.
